(19) United States
(12) Patent Application Publication
(10) Pub. No.: US 2016/0084798 A1
(43) Pub. Date: Mar. 24, 2016

(54) ANALYSIS METHOD

(71) Applicants: SHARP KABUSHIKI KAISHA, Osaka (JP); NATIONAL CANCER CENTER, Tokyo (JP)

(72) Inventors: Hideki KINOSHITA, Osaka-shi (JP); Yutaka UNUMA, Osaka-shi (JP); Tadashi KONDO, Tokyo (JP)

(73) Assignees: Sharp Kabushiki Kaisha, Abeno-ku, Osaka-shi, Osaka (JP); National Cancer Center, Tokyo (JP)

(21) Appl. No.: 14/779,713

(22) PCT Filed: Jan. 31, 2014
(86) PCT No.: PCT/JP2014/052245

§ 371 Date: Sep. 24, 2015

(30) Foreign Application Priority Data
Mar. 29, 2013 (JP) 2013-071753

(51) Int. Cl. G01N 27/447

(52) U.S. Cl. CPC G01N 27/44795; G01N 27/44778

(57) ABSTRACT

An analysis method includes the steps of performing two-dimensional electrophoresis of analysis objects in an isoelectric direction and in a molecular weight direction that is substantially perpendicular to the isoelectric direction, cutting a medium containing the analysis objects, which have been subjected to the two-dimensional electrophoresis, in a lattice pattern along cut planes in the isoelectric direction and along cut planes in the molecular weight direction, and comparing the analysis objects between the cut mediums.

### TECHNICAL FIELD

The present invention relates to an analysis method.

This application claims the priority on the basis of Japanese Patent Application No. 2013-071753 filed in Japan on Mar. 29, 2013, the entire contents of which are hereby incorporated by reference.

### BACKGROUND ART

In recent years, proteomic analysis has intensively been performed as an approach for globally analyzing proteins that directly support biological activities. The term “proteome” means the entirety of proteins produced in particular cells, organs, and other body parts. Two-dimensional electrophoresis, which is one of techniques for the proteomic analysis, is widely used as a method for separating a biological sample, e.g., proteins, because it has a high resolution and is able to detect several thousand kinds of proteins at a time. In the two-dimensional electrophoresis, proteins are separated by isoelectric focusing in accordance with their physical properties, and are further separated by SDS-PAGE in the molecular weight direction. The term “isoelectric focusing” means a method of applying a voltage to a gel and separating proteins depending on the differences in isoelectric points of the proteins. In the separation by SDS-PAGE, SDS-poly-acrylamide gel electrophoresis (i.e., SDS-PAGE) is widely utilized which performs the electrophoresis in a state where sodium dodecyl sulfate (SDS) serving as a cationic surfactant and protein form a complex.

With the two-dimensional electrophoresis, proteins are each detected as a spot in a poly-acrylamide gel on a flat plate. Furthermore, there is a peptide mass fingerprinting method as a technique for identifying the protein in each protein spot. The type of protein in the spot can be determined by employing the peptide mass fingerprinting method. According to that method, it is possible to transfer the separated spot in the gel to a film, and to identify the protein in a film spot in a similar manner.

In the peptide mass fingerprinting method, each protein spot is cut out in a state of the gel, and the cut-out gel having a plug-like shape is transferred to a chamber that does not allow leakage of a liquid buffer therefrom. After performing replacement with use of a trypsin processing buffer, the protein in the gel is digested to peptide by employing a proteolytic enzyme, e.g., trypsin. Mass analysis using a mass analyzer is performed on the peptide eluted from the gel, and the protein before the digestion is identified by comparing and collating respective patterns of a mass spectrum of a peptide segment expected from the protein, which is estimated from a database in advance, and a measured mass spectrum.

In relation to the cutting-out of each spot or band, there are known methods of cutting out, e.g., the spot or band with an edge tool, such as a razor or a surgical knife, a peptide chip, or an automatic cutting device with a tubular tool (see Patent Literature (PTL) 1). There is also known a method of cutting out one block that contains the protein separated by the two-dimensional electrophoresis, and digesting the protein in the gel to peptide (see Non Patent Literature (NPL) 1).

While the above-described methods are each intended to analyze a part of the separated biological samples, a method for fractionating a gel into a plurality of gels is also known. NPL 2 discloses a method of fractionating proteins separated by the isoelectric focusing in a solution, and a method of fractionating proteins, which have been separated by SDS-PAGE, by eluting the proteins into a solution. Those fractionated proteins are each fractionated depending on only one physical property of the protein. Thus, the fractionation is performed on the basis of only the actual molecular weight or isoelectric point.

### CITATION LIST

### Patent Literature

PTL 1: Japanese Unexamined Patent Application Publication No. 2007-209360

### Non Patent Literatures

NPL 1: PNAS vol. 97, NO. 17, 15 Aug. 2000, 9390-9395
NPL 2: Nature vol. 480, 8 Dec. 2011, p 254

### SUMMARY OF INVENTION

### Technical Problem

In the method stated in NPL 2, however, because the fractionation is performed on the basis of only the molecular weight or the isoelectric point, sufficient information related to analysis objects, e.g., proteins cannot be obtained in some cases. More specifically, in the case of the fractionation on the basis of only the molecular weight, because information about shifts of isoelectric points is not obtained, modification information after protein translation is unclear. In the case of the fractionation on the basis of only the isoelectric points, fluctuations in the mass direction caused by processing, glycosylation, etc. are unclear. In the method stated in NPL 1, because one block is cut out, information about protein processing cannot be obtained as in the above case.

The present invention has been made in view of the above-described situations, and one object of the present invention is to detect analysis objects, which have been separated by two-dimensional electrophoresis, by a mass analyzer with high sensitivity in a state of still holding a particular isoelectric region and a particular molecular weight region.

### Solution to Problem

One aspect of the present invention provides an analysis method including the steps of performing two-dimensional electrophoresis of analysis objects in an isoelectric direction and in a molecular weight direction that is substantially perpendicular to the isoelectric direction, cutting a medium containing the analysis objects, which have been subjected to the two-dimensional electrophoresis, in a lattice pattern along cut planes in the isoelectric direction and along cut planes in the molecular weight direction, and comparing the analysis objects between the cut mediums.

### Advantageous Effects of Invention

According to one aspect of the present invention, the analysis objects having been separated by the two-dimensional electrophoresis can be detected by a mass analyzer with high sensitivity in a state of still holding a particular isoelectric region and a particular molecular weight region.

### BRIEF DESCRIPTION OF DRAWINGS

FIG. 1 is one example of a flowchart illustrating a flow of an analysis method according to a first embodiment.

FIG. 2 illustrates one example of an external shape of an IPG gel strip 1.

FIG. 3 illustrates one example of a configuration of an isoelectric focusing apparatus 10.

FIG. 4 is a perspective view of a part of a second dimensional electrophoresis apparatus 30 and is a sectional view taken along a line A-A in the perspective view.

FIG. 5 illustrates a state where the IPG gel strip 1 is introduced to the second dimensional electrophoresis apparatus 30.

FIG. 6 illustrates one example of an image obtained by imaging a sample separating medium (gel) 37 after execution of two-dimensional electrophoresis.

FIG. 7A illustrates cut planes along which the gel is cut.

FIG. 7B illustrates a sample separating section 36 after cut blocks of the gel have been removed.

FIG. 8 illustrates a method of indicating information that is obtained by combining a method of dividing a sample into blocks and the protein expression comparison using MS-based proteomics with each other.

FIG. 9 illustrates a manner of detecting the difference in posttranslational modification per block.

FIG. 10A illustrates a sample separating medium support plate 70 that enables the molecular weight and the isoelectric point at a cut position to be estimated.

FIG. 10B illustrates a state where the sample separating medium is set on the sample separating medium support plate 70 that enables the molecular weight and the isoelectric point at the cut position to be estimated.

FIG. 10C illustrates a state after gel blocks have been cut out from the sample separating medium set on the sample separating medium support plate 70 that enables the molecular weight and the isoelectric point at the cut position to be estimated.

FIG. 11 illustrates an example of the estimated molecular weight and isoelectric point per block.

### DESCRIPTION OF EMBODIMENTS

Embodiments of an analysis method of the present invention will be described below with reference to the drawings.

### First Embodiment

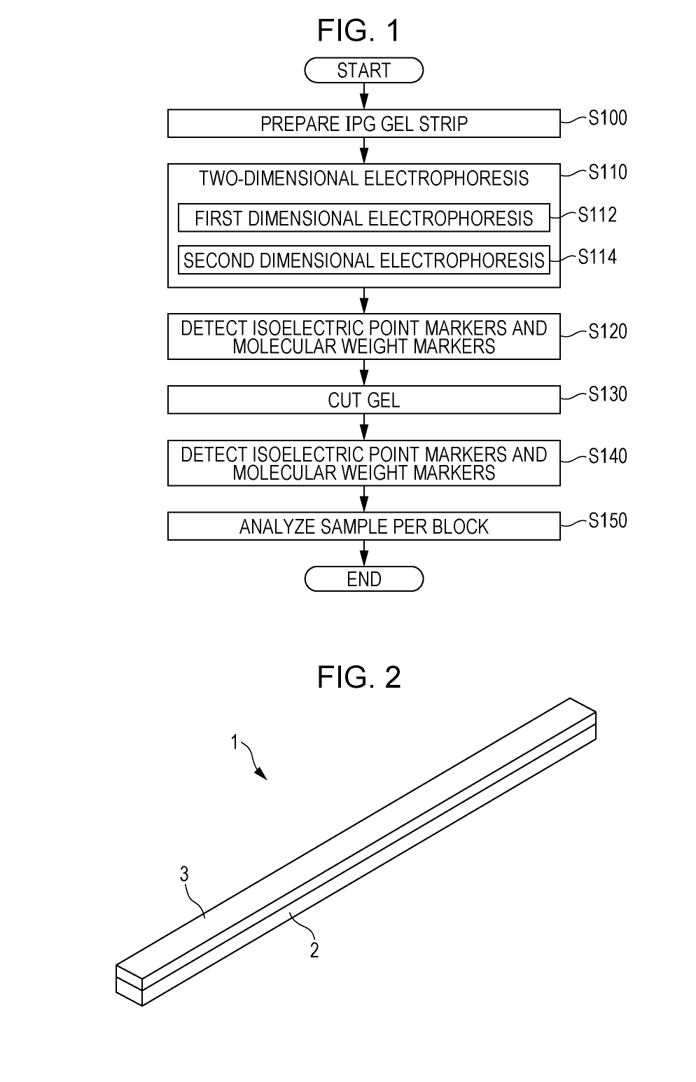

FIG. 1 is one example of a flowchart illustrating a flow of an analysis method according to a first embodiment. First, an analyst prepares an IPG (Immobilized pH-gradient) gel strip 1 (step S100). FIG. 2 illustrates one example of an external shape of the IPG gel strip 1. As illustrated in FIG. 2, the IPG gel strip 1 includes a sample containing medium 2 for one-dimensional electrophoresis, and a support 3 supporting the sample containing medium 2. The sample containing medium 2 is a medium in which a sample (analysis object) is separated by isoelectric focusing. The sample is, for example, a biological sample such as proteins. The sample containing medium 2 may be a gel that is usually employed as a gel for first dimensional electrophoresis of two-dimensional electrophoresis. A preferably used example of the sample containing medium 2 is an IPG (Immobilized pH gradient) gel that has been turned into a gel with a gelling agent selected from a group consisting of polyacrylamide, agarose, agar, and starch.

For example, a plastic plate or film may be used as the support 3.

A dye in a first color is applied to the sample that is contained the sample containing medium 2. Furthermore, the sample containing medium 2 is mixed, for example, with not only isoelectric point markers that are made of a plurality of substances having the known isoelectric points and having relatively small molecular weights, and that are added with a dye in a second color, but also molecular weight markers that are made of a plurality of substances (peptides) having small isoelectric points and having the known molecular weights, and that are added with a dye in a third color. The analyst mixes and applies peptides of p1=[4, 0], [5, 0], [6, 2], [7, 3], [8, 8], and [9, 6], for example, in a mixed state to the IPG gel strip 1 having pH 3 to 10 such that peptide spots are arrayed at substantially equal intervals. The meaning of the above-mentioned process will be described later. Before starting the second dimensional electrophoresis, the analyst may add the molecular weight markers into regions not overlapping the sample.

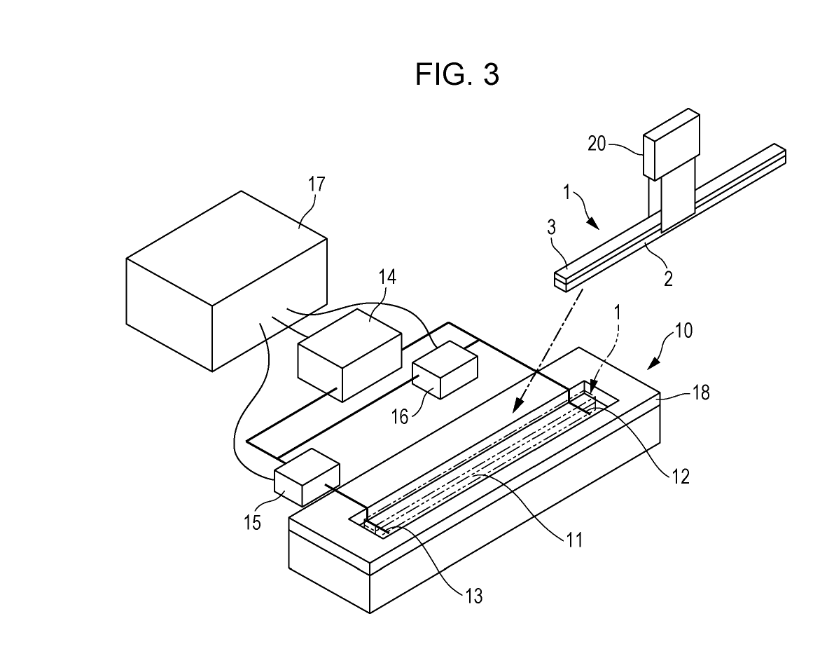

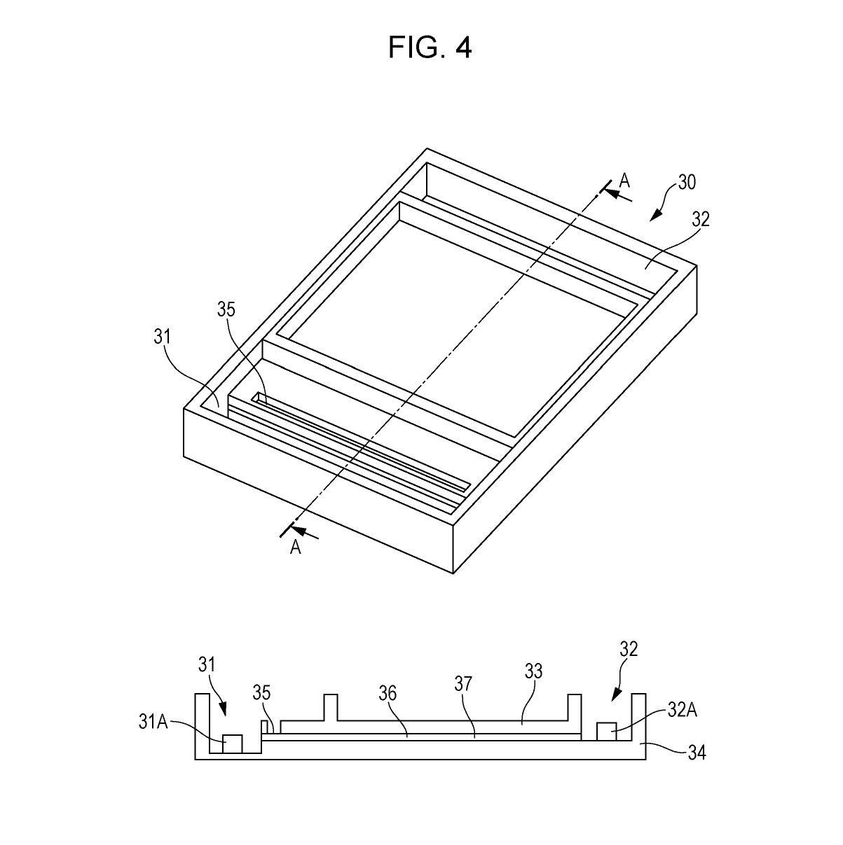

Returning to FIG. 1, the analyst performs the two-dimensional electrophoresis on the IPG gel strip 1 (step S110; including S112 to S116). First, the analyst introduces the IPG gel strip 1 to an isoelectric focusing apparatus 10 and performs the first dimensional electrophoresis (isoelectric focusing) (step S112). FIG. 3 illustrates one example of a configuration of the isoelectric focusing apparatus 10. As illustrated in FIG. 3, the isoelectric focusing apparatus 10 has a rectangular parallelepiped shape and includes an electrophoresis chamber 11, which is formed in a central portion and which has an elongate rectangular shape. A first electrode 12 in contact with an acidic-side end portion of the sample containing medium 2 is disposed at one end side of the electrophoresis chamber 11 in the lengthwise direction, and a second electrode 13 in contact with a basic-side end portion of the sample containing medium 2 is disposed at the other end side of the electrophoresis chamber 11. The first electrode 12 and the second electrode 13 are connected to a power supply 14.

A voltage applied between the first electrode 12 and the second electrode 13 is controlled by a voltage control unit 17. Respective values detected by an ampere meter 15 measuring a current, which flows through the first electrode 12 and the second electrode 13, and detected by a voltmeter 16 measuring the voltage applied between the first electrode 12 and the second electrode 13 are both input to the voltage control unit 17. The isoelectric focusing apparatus 10 further includes a cover 18 to prevent drying of the sample containing medium 2 during the electrophoresis.

The isoelectric focusing is performed by placing the IPG gel strip 1 into the electrophoresis chamber 11 with a clip 20 for carrying the strip, and then applying the voltage between the first electrode 12 and the second electrode 13 that are in contact with the IPG gel strip 1. More specifically, the isoelectric focusing is performed by applying the voltage after swelling the IPG gel strip 1 with a swelling liquid containing proteins and made up of 8 M of Urea, 2 M of Thiourea, 4% of CHAPS (3-[(3-Cholamidopropyl) dimethylammonio]propanesulfonate), 20 mM of dithiothreitol, and 0.5% of Ampholyte. The voltage control unit 17 gradually increases the voltage, thus causing the proteins to be converged to isoelectric points.

In one example, the voltage control unit 17 increases the voltage through a sequence of maintaining 200 V for 5 minutes, raising the voltage from 200 V to 1000 V in 5 minutes, maintaining 1000 V for 5 minutes, raising the voltage from 1000 V to 6000 V in 10 minutes, and maintaining 6000 V for 5 minutes. With the isoelectric focusing, the proteins contained in the sample containing medium 2 are caused to migrate through distances corresponding to respective isoelectric points (pI) in the lengthwise direction of the sample containing medium 2.

Returning to FIG. 1, the analyst introduces the IPG gel strip 1 to a second dimensional electrophoresis apparatus 30 and performs the second dimensional electrophoresis (step S114). FIG. 4 is a perspective view of a part of the second dimensional electrophoresis apparatus 30 and is a sectional view taken along a line A-A in the perspective view. The second dimensional electrophoresis apparatus 30 includes a cathode buffer tank 31 for the second dimensional electrophoresis in which a cathode 31A is disposed, an anode buffer tank 32 for the second dimensional electrophoresis in which an anode 32A is disposed, an upper base plate 33, a sample separating medium support plate 34, a sample loading section 35 into which the IPG gel strip 1 is introduced, and a sample separating section 36. The sample separating section 36 is filled with a sample separating medium (gel) 37 to separate the sample that has been subjected to the first dimensional electrophoresis.

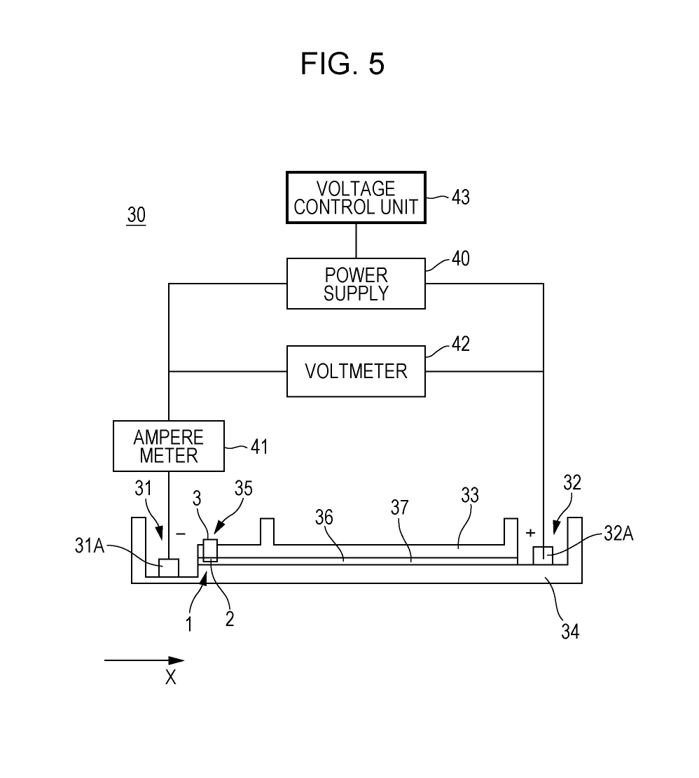

FIG. 5 illustrates a state where the IPG gel strip 1 is introduced to the second dimensional electrophoresis apparatus 30. As illustrated in FIG. 5, the IPG gel strip 1 is placed into the sample loading section 35 with the sample containing medium 2 directed downward in the drawing. In such a state, a migration buffer (i.e., a liquid reagent for establishing electric conduction between the gel and the electrodes) is filled in the cathode buffer tank 31 and the anode buffer tank 32 for the second dimensional electrophoresis. The second dimensional electrophoresis apparatus 30 further includes a power supply 40 and a voltage control unit 43. A voltage applied between the cathode 31A and the anode 32A is controlled by the voltage control unit 43. Respective values detected by an ampere meter 41 measuring a current, which flows through the cathode 31A and the anode 32A, and detected by a voltmeter 42 measuring the voltage applied between the cathode 31A and the anode 32A are input to the voltage control unit 43.

Before starting the second dimensional electrophoresis, the analyst immerses the IPG gel strip 1 in an aqueous solution containing, for example, 50 mM of DTT, 500 mM of Tris-HCl (pH 6.6), 4% of SDS, 12.5% of Glycerol, and 0.005% of BPB for 5 min. Thereafter, the analyst places the IPG gel strip 1 into the sample loading section 35, and performs the electrophoresis for 30 min by applying the desired voltage between the cathode 31A and the anode 32A at 20 mA, for example. As a result, the proteins having migrated in the lengthwise direction of the IPG gel strip 1 with the isoelectric focusing can be caused to migrate in the X-direction in FIG. 5.

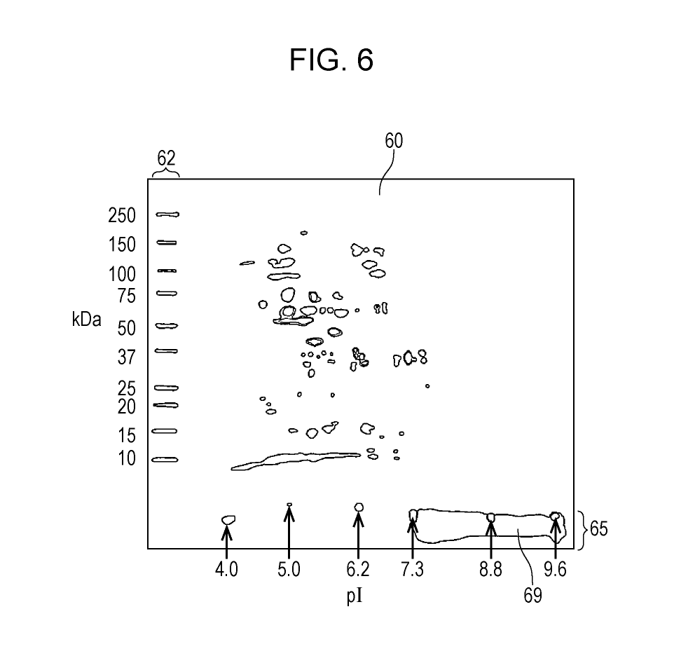

FIG. 6 illustrates one example of an image obtained by imaging the sample separating medium (gel) 37 after execution of the two-dimensional electrophoresis. As illustrated in FIG. 6, on the sample separating medium 37, the analyst can visually recognize a plurality of molecular weight markers 62 that are arrayed in the vertical direction at the left end, and a plurality of isoelectric point markers 65 (i.e., spots denoted by arrows in the drawing) that are arrayed in the horizontal direction at the lower end. A numeral “69” in FIG. 6 indicates a pool of dyes having relatively large electric charges and having not reacted with the sample. Furthermore, “kDa” in FIG. 6 indicates kilo Dalton, i.e., a unit representing the molecular weight.

Returning to FIG. 1, the analyst detects the isoelectric point markers and the molecular weight markers (step S120), and cuts the gel with, e.g., a razor (step S130). The analyst cuts the gel in a lattice pattern (into blocks) along cut planes in the isoelectric direction (i.e., the vertical direction in FIG. 6) and along cut planes in the molecular weight direction (i.e., the horizontal direction in FIG. 6). An edge of the razor may be made of, e.g., resin, ceramic, or metal that is harder than the gel, and the edge is preferably as thin as possible not to generate gel fragments when the gel is cut.

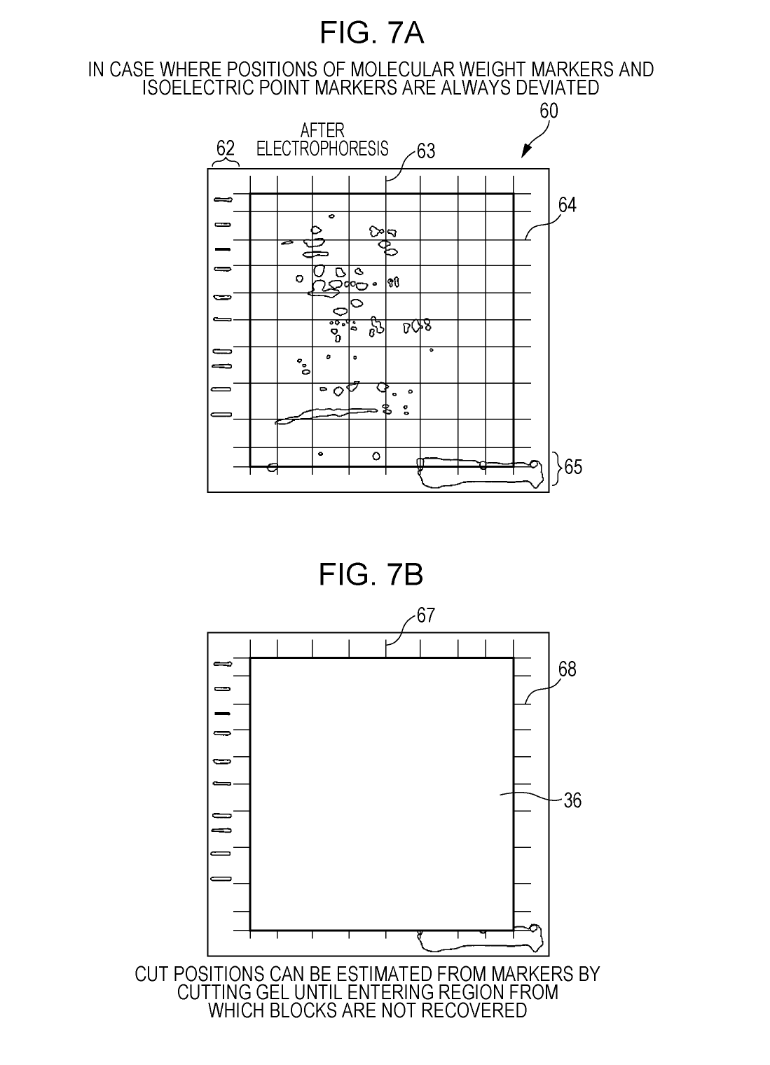

FIGS. 7A and 7B illustrate, respectively, the cut planes along which a gel 60 is cut, and the sample separating section 36 after cut blocks of the gel 60 have been removed. FIG. 7A represents a state immediately after the gel 60 has been cut, and FIG. 7B represents a state after the cut blocks of the gel 60 have been removed. The cutting of the gel 60 is performed at vertical cutting positions 63 and horizontal cutting positions 64 in a manner of not cutting both the molecular weight markers 62 and the isoelectric point markers 65. By employing the razor having an edge with a larger length than the block in the case of cutting the gel, vertical cut traces 67 and horizontal cut traces 68 remain. A molecular weight position and an isoelectric position at each cut position can be calculated by comparing the above-mentioned cut traces, which have been generated by the cutting, with respective positions of the molecular weight markers and the isoelectric point markers.

Returning to FIG. 1, the analyst detects the isoelectric point markers and the molecular weight markers (step S140), and analyzes the sample per block (step S150). The analyst shapes the cut block of the gel into the size of about 1 mm³, for example, transfers the gel block to a container, e.g., a microtube or a microplate, and performs digestion of the proteins in the gel. Then, the analyst de-stains the gel by adding 50 μL of 100% acetonitrile (CH₃CN) and 50 μL of 50-mM hydrogen ammonium carbonate (NH₄HCO₃), and leaving the gel to stand in a stationary state at the room temperature. Then, the analyst reduces the proteins by adding 100 μL of 100% CH₃CN and leaving the sample to stand in a stationary state for 10 min at the room temperature, adding 10 mM of (DTT) and 50 mM of (NH₄HCO₃) and leaving the sample to stand in a stationary state for 10 min at 60° C., and further leaving the sample to stand in a stationary state for 20 min. Then, the analyst performs alkylation by adding 30 μL of 50-mM iodoacetamide and 50-mM (NH₄HCO₃), and leaving the sample to stand for 15 min at the room temperature. Then, the analyst performs steps of adding 40 of 50-mM (NH₄HCO₃) and leaving the sample to stand for 15 min at the room temperature, adding 100 μL of 100% CH₃CN and leaving the sample to stand in a stationary state for 30 min at the room temperature, discharging a liquid in a well, and further leaving the sample to stand in nitrogen for 10 min. Then, the analyst adds 25 μl of a trypsin digestion solution, and performs incubation at 30° C. during one night, thus obtaining extracted peptides as a specimen for a mass analyzer. The above-mentioned digestion solution may be endopeptidase, and it is not limited to trypsin. A method for digesting the proteins in the gel is also not limited to the above-mentioned one. A method for identifying the proteins from peptide data, which has been detected by the mass analyzer, is practiced by employing software to execute collation with respect to the database, such as MASCOT, X!Tandem, OMASSA, or Andromeda.

The cutting process in the present invention can be combined with a method for comparatively quantitating protein expression by employing MS-based proteomics. After labeling proteins with label compounds that are different between samples, and mixing the samples to each other, the two-dimensional electrophoresis is performed on the mixed samples. A gel after the two-dimensional electrophoresis is cut into blocks in accordance with the above-described method. Peptides are extracted from the gel block and are analyzed by the mass analyzer. Respective physical properties of the labeled proteins and peptides are not changed, but the masses thereof and the masses of tag molecules used as the labels are slightly different. Therefore, even when the labeled proteins are analyzed at the same time, the individual proteins contained in the different samples can be discriminated on the basis of mass differences. It is hence possible to compare the differences in amounts of the individual proteins.

Thus, deviations resulting from the differences in the two-dimensional electrophoresis, the differences in efficiency of the in-gel digestion and the elution of peptides, the differences in the elution time of a liquid chromatography, and the differences in a mass analyzer can be minimized by mixing protein samples to be compared, and by analyzing those samples at the same time. Examples of the label compounds used for the labeling are SILAC, ¹⁵N, ¹⁸O, TNT, and iTRAQ. SILAC and ¹⁵N are metabolic labels and are each used to label protein that is newly synthesized in a cell by making, e.g., amino acids or nitric acid labeled with a stable isotope, absorbed in the cell. On the other hand, ¹⁸O, TNT, and iTRAQ are chemical labels and are each able to directly label the extracted protein or peptide by reacting it with a stable isotope or a tag molecule, which contains a stable isotope, in a test tube. Metabolically labeled samples and directly labeled samples can be both used in the method of this embodiment.

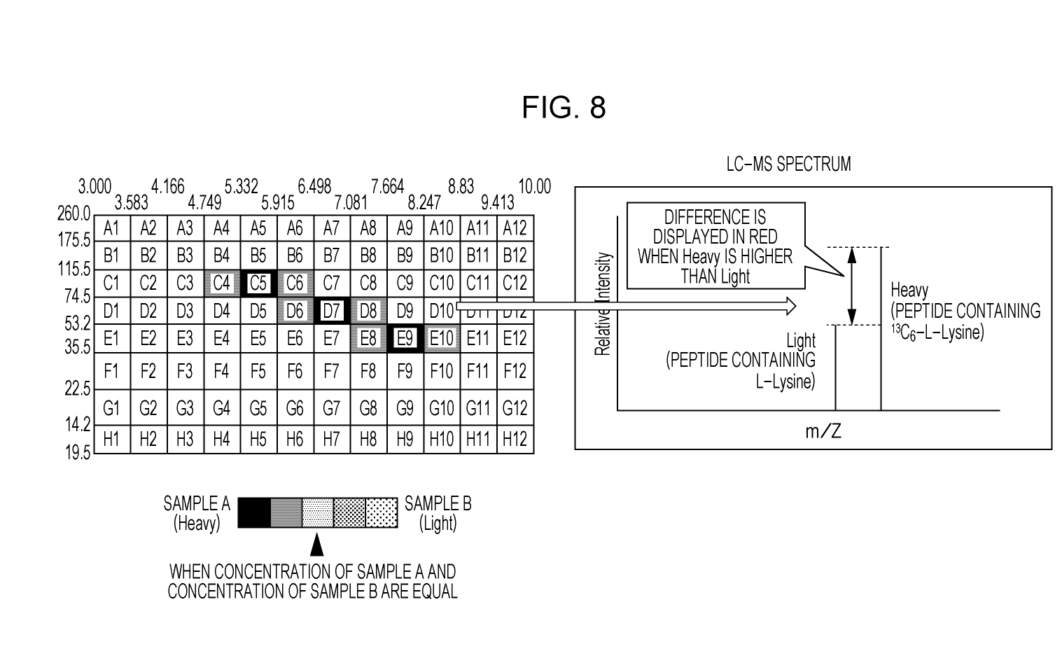

FIG. 8 illustrates a method of representing information that is obtained by combining the method of dividing a sample into blocks and the protein expression comparison using MS-based proteomics with each other. Many of translated proteins are post-translationally modified. Therefore, each protein is detected in a plurality of blocks if the protein is post-translationally modified. In the SILAC (stable isotope labeling using amino acids in cell culture) method, because labeling is made using stable isotopes different between samples, the respective isoelectric points and molecular weights of target proteins in the different samples are substantially the same, and those proteins are detected in the same block. Expression levels of those proteins can be compared on the basis of MS peak values (see an LC-MS spectrum in FIG. 8). Thus, the difference between the samples can be clearly indicated by representing the detection results in the form of two-dimensional heat map depending on the expression levels of those proteins as illustrated in FIG. 8. In the case of the same protein, it is expected that an increase and a decrease in the expression levels have the same tendency in all the detected zones in FIG. 8.

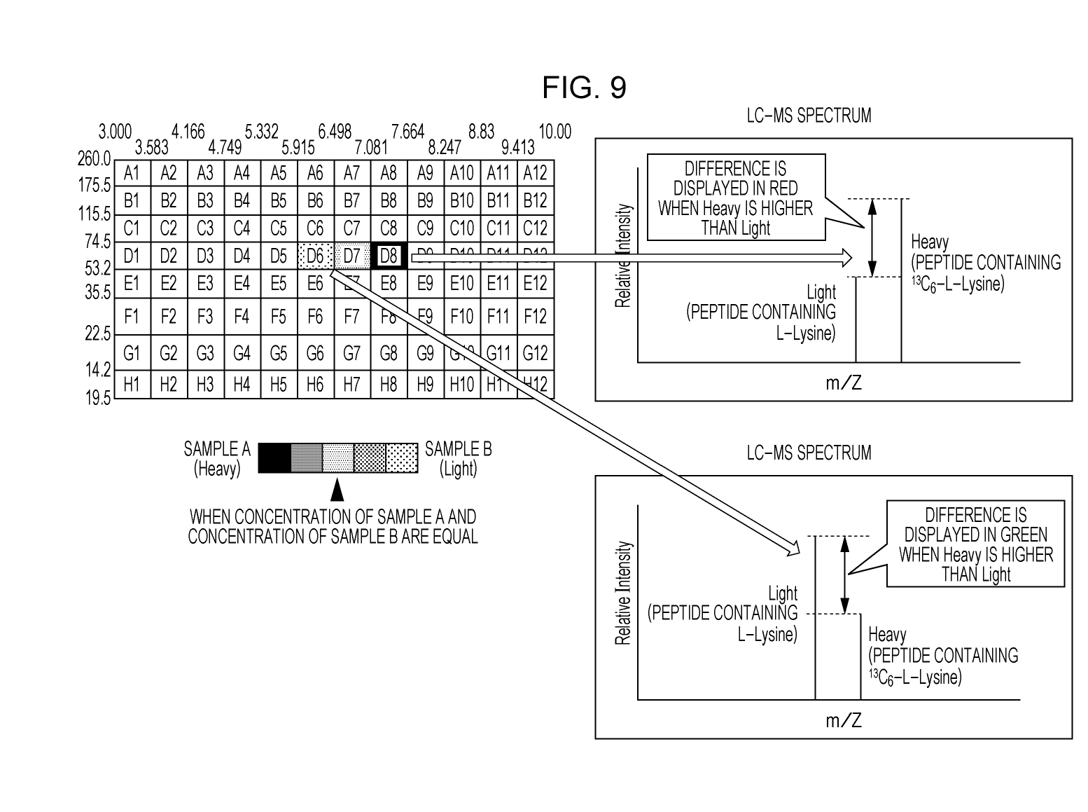

More specifically, proteins are prepared from a cell that has been cultivated in a culture containing natural L-Lysine hydrochloride (Light), and from a cell that has been cultivated in a culture added with ¹³C₆-L-Lysine hydrochloride (Heavy). The prepared samples are mixed in equal amounts to each other. After performing the two-dimensional electrophoresis described above, a gel is divided into blocks, and the proteins in the gel are subjected to in-gel digestion using trypsin. The masses of obtained peptides are measured by a mass analyzer. The proteins can be identified from the measured results by employing MASCOT. Even the same protein is identified over a plurality of blocks due to the posttranslational modification of the protein. It is also possible per block to detect not only whether there is a difference in translation level of the protein between the samples to be compared, but also a difference in the posttranslational modification if the difference is present (FIG. 9).

According to the above-described analysis method of the first embodiment, since a medium containing a sample after being subjected to two-dimensional electrophoresis is cut in a lattice pattern along cut planes in the isoelectric direction and along cut planes in the molecular weight direction and sample comparison is performed between the cut mediums, analysis objects having been separated by the two-dimensional electrophoresis can be detected by a mass analyzer with high sensitivity in a state of still holding a particular isoelectric region and a particular molecular weight region.

Furthermore, according to the analysis method of the first embodiment, since a protein-mixed liquid sample is finely fractionated, the proteins in low concentrations can be detected, differences in processing and posttranslational modification of the proteins can be compared, and modified positions of the proteins can be estimated with detailed fractionation.

### Second Embodiment

An analysis method of a second embodiment will be described below. In the analysis method of the second embodiment, the isoelectric points and the molecular weights of the cut blocks are confirmed on the basis of reference marks, which are attached to a sample separating medium support plate, instead of using the isoelectric point markers and the molecular weight markers.

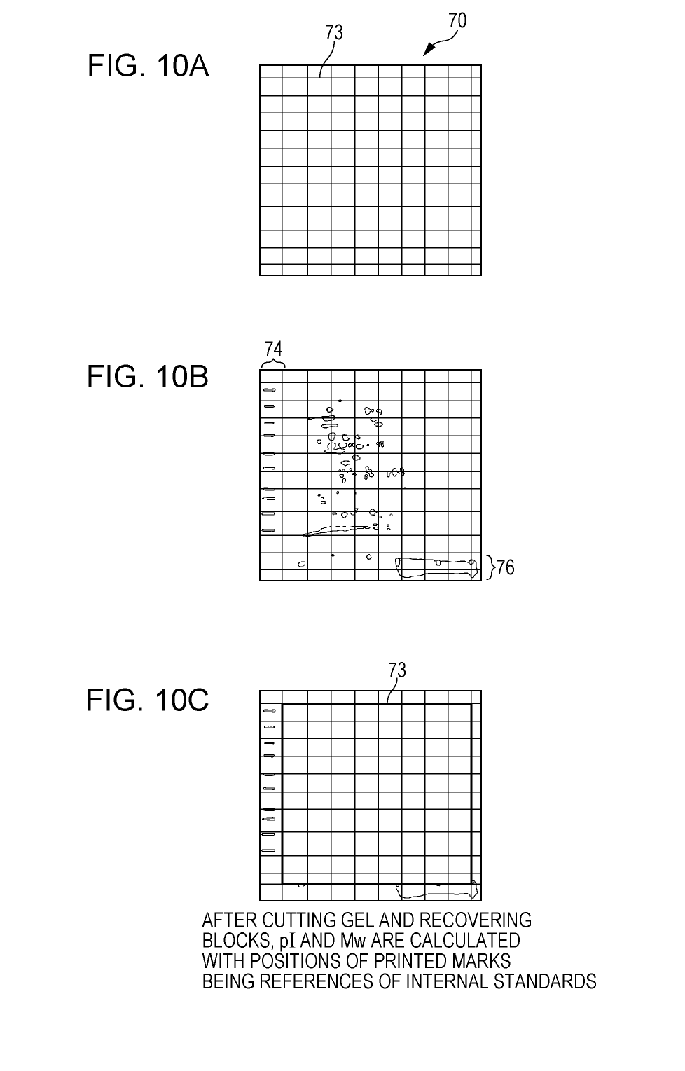

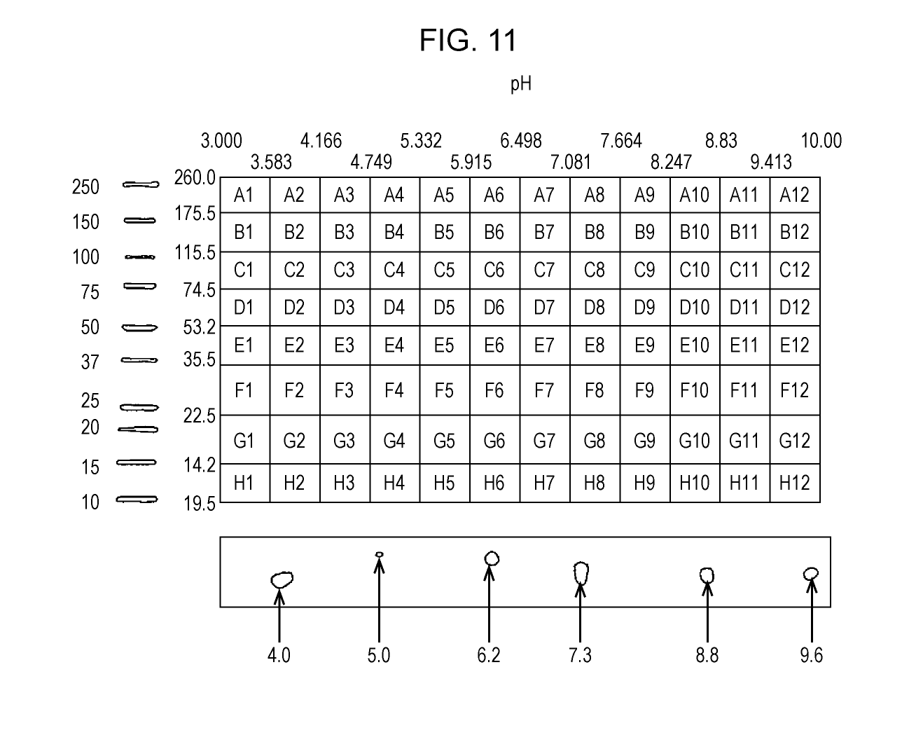

FIGS. 10A to 10C illustrate a manner of using a sample separating medium support plate 70 that enables the molecular weight and the isoelectric point at a cut position to be estimated. As illustrated in FIG. 10A, in the sample separating medium support plate 70, cut positions are previously drawn as lines (reference marks) 73, e.g., fluorescent lines, which can be preferably detected at the same time as when proteins are detected, by employing, e.g., a pen or a laser processor. The lines 73 are printed, for example, with fluorescent dyes having the same wavelengths as those of the above-described markers. FIG. 10B illustrates a state where a gel is placed on the sample separating medium support plate 70. After the two-dimensional electrophoresis, the gel is cut along the lines 73, and gel blocks are transferred into a chamber or the like. In FIGS. 10B and 10C, molecular weight markers 74 and isoelectric point markers 76, which can be omitted in this embodiment, are also illustrated for comparison. As illustrated in FIG. 10C, the accurate molecular weights and isoelectric points at the cut positions can be confirmed by comparing the positions of the molecular weight markers and the isoelectric point peptide markers, which have been detected after the electrophoresis, with the positions of the lines 73. FIG. 11 illustrates an example of the molecular weighs and the isoelectric points that are estimated per block.

An analysis executed subsequently per block is the same as that in the first embodiment, and therefore description of the analysis is omitted here.

According to the above-described analysis method of the second embodiment, since a medium containing a sample after being subjected to two-dimensional electrophoresis is cut in a lattice pattern along cut planes in the isoelectric direction and along cut planes in the molecular weight direction and sample comparison is performed between cut blocks of the medium, analysis objects having been separated by the two-dimensional electrophoresis can be detected by a mass analyzer with high sensitivity in a state of still holding a particular isoelectric region and a particular molecular weight region.

Furthermore, according to the analysis method of the second embodiment, since a protein-mixed liquid sample is finely fractionated, the proteins in low concentrations can be detected, differences in processing and posttranslational modification of the proteins can be compared, and modified positions of the proteins can be estimated with further detailed fractionation.

While modes for carrying out the present invention have been described above in connection with the embodiments, the present invention is in no way limited to the foregoing embodiments, and various modifications and substitutions can be made on the present invention within the scope not departing from the gist of the present invention.

The present invention can be practiced in the following forms.

### APPENDIX 1

An analysis method comprising a step (step S110) of performing two-dimensional electrophoresis of analysis objects in an isoelectric direction and in a molecular weight direction that is substantially perpendicular to the isoelectric direction, a step (step S120) of cutting a medium containing the analysis objects, which have been subjected to the two-dimensional electrophoresis, in a lattice pattern along cut planes in the isoelectric direction and along cut planes in the molecular weight direction, and a step (step S130) of comparing the analysis objects between the cut mediums (FIG. 1).

### APPENDIX 2

The analysis method according to Appendix 1, further comprising a step of mixing markers having known isoelectric points and known molecular weights into the medium before first dimensional electrophoresis and/or second dimensional electrophoresis such that, in a state after execution of the two-dimensional electrophoresis, markers (62, 65) recognizable by an analyst are arranged at a plurality of reference molecular weight positions and a plurality of reference isoelectric point positions.

### APPENDIX 3

The analysis method according to Appendix 1, wherein a support member (70) for holding the medium containing the analysis objects, which have been subjected to the two-dimensional electrophoresis, includes reference marks (73) representing molecular weights and isoelectric points, and the molecular weights and the isoelectric points confirmed from the reference marks are used in the step of comparing the analysis objects.

### APPENDIX 4

The analysis method according to any one of Appendixes 1 to 3, wherein amounts of the analysis objects having been identified are compared in the step of comparing the analysis objects.

### APPENDIX 5

The analysis method according to any one of Appendixes 1 to 4, wherein the analysis objects are proteins, and differences in posttranslational modification are compared by comparing the identified proteins in the step of comparing the analysis objects.

### APPENDIX 6

The analysis method according to any one of Appendixes 1 to 5, wherein the analysis objects are proteins, and the step of comparing the analysis objects is executed by extracting the proteins contained in the cut mediums, and identifying the extracted proteins by a mass analyzer.

### APPENDIX 7

The analysis method according to any one of Appendixes 1 to 6, wherein the analysis objects are proteins, and the step of comparing the analysis objects is executed by digesting the proteins contained in the cut mediums with a proteolytic enzyme, extracting peptides generated with the digestion, and identifying the extracted proteins by a mass analyzer.

### APPENDIX 8

The analysis method according to any one of Appendixes 1 to 7, wherein the analysis objects are a mixture of protein samples labeled with different stable isotopes.

### APPENDIX 9

The analysis method according to any one of Appendixes 1 to 7, wherein the analysis objects are proteins, and the step of comparing the analysis objects is executed by splitting the proteins contained in the cut mediums with endopeptidase, and performing identification of the proteins and comparison of amounts of different stable isotope proteins by a mass analyzer.

### INDUSTRIAL APPLICABILITY

The present invention can be suitably applied to means for separating a biological sample, e.g., proteins, through electrophoresis, cutting out a sample separating medium that contains the separated biological samples, and identifying or analyzing the samples in the sample separating medium by a mass analyzer.

### REFERENCE SIGNS LIST

1 . . . IPG gel strip, 2 . . . sample containing medium, 3 . . . support, 10 . . . isoelectric focusing apparatus, 11 . . . electrophoresis chamber, 12 . . . first electrode, 13 . . . second electrode, 14 . . . power supply, 15 . . . ampere meter, 16 . . . voltmeter, 17 . . . voltage control unit, 18 . . . cover, 30 . . . second dimensional electrophoresis apparatus, 31 . . . cathode buffer tank for second dimensional electrophoresis, 31A . . . cathode, 32 . . . anode buffer tank for second dimensional electrophoresis, 32A . . . anode, 33 . . . upper base plate, 34 . . . sample separating medium support plate, 35 . . . sample loading section, 36 . . . sample separating section, 37 . . . sample separating medium, 40 . . . power supply, 41 . . . ampere meter, 42 . . . volt meter, 43 . . . voltage control unit, 60 . . . gel, 62 . . . molecular weight markers, 63 . . . cut positions in vertical direction, 64 . . . cut positions in horizontal direction, 65 . . . isoelectric point markers, 67 . . . cut traces in vertical direction, 68 . . . cut traces in horizontal direction, 70 . . . sample separating medium support plate, 73 . . . lines

1. An analysis method comprising the steps of:
performing two-dimensional electrophoresis of analysis objects in an isoelectric direction and in a molecular weight direction that is substantially perpendicular to the isoelectric direction;
cutting a medium containing the analysis objects, which have been subjected to the two-dimensional electrophoresis, in a lattice pattern along cut planes in the isoelectric direction and along cut planes in the molecular weight direction; and
comparing the analysis objects between the cut mediums.

2. The analysis method according to claim 1, further comprising a step of mixing markers having known isoelectric points and known molecular weights into the medium before first dimensional electrophoresis and/or second dimensional electrophoresis such that, in a state after execution of the two-dimensional electrophoresis, markers recognizable by an analyst are arranged at a plurality of reference molecular weight positions and a plurality of reference isoelectric point positions.

3. The analysis method according to claim 1, wherein a support member for holding the medium containing the analysis objects, which have been subjected to the two-dimensional electrophoresis, includes reference marks representing molecular weights and isoelectric points, and the molecular weights and the isoelectric points confirmed from the reference marks are used in the step of comparing the analysis objects.

4. The analysis method according to claim 1, wherein amounts of the analysis objects having been identified are compared in the step of comparing the analysis objects.

5. The analysis method according to claim 1, wherein the analysis objects are proteins, and
differences in posttranslational modification are compared by comparing the identified proteins in the step of comparing the analysis objects.

6. The analysis method according to claim 1, wherein the analysis objects are proteins, and
the step of comparing the analysis objects is executed by extracting the proteins contained in the cut mediums, and identifying the extracted proteins by a mass analyzer.

7. The analysis method according to claim 1, wherein the analysis objects are proteins, and
the step of comparing the analysis objects is executed by digesting the proteins contained in the cut mediums with a proteolytic enzyme, extracting peptides generated with the digestion, and identifying the extracted proteins by a mass analyzer.

8. The analysis method according claim 1, wherein the analysis objects are a mixture of protein samples labeled with different stable isotopes.

9. The analysis method according to claim 1, wherein the analysis objects are proteins, and
the step of comparing the analysis objects is executed by splitting the proteins contained in the cut mediums with endopeptidase, and performing identification of the proteins and comparison of amounts of different stable isotope proteins by a mass analyzer.
